(19) United States
(12) Patent Application Publication
(10) Pub. No.: US 2026/0143435 A1
(43) Pub. Date: May 21, 2026

(54) POWER MANAGEMENT IN DUAL-CONNECTIVITY

(71) Applicant: Nokia Technologies Oy, Espoo (FI)

(72) Inventors: Tero HENTTONEN, Espoo (FI); Samuli Heikki TURTINEN, Ii (FI); Chunli WU, Beijing (CN); Jarkko Tuomo KOSKELA, Oulu (FI); Lars DALSGAARD, Oulu (FI)

(73) Assignee: Nokia Technologies Oy, Espoo (FI)

(21) Appl. No.: 18/706,121

(22) PCT Filed: Nov. 1, 2021
(86) PCT No.: PCT/CN2021/127993

§ 371 Date: Apr. 30, 2024

(51) Int. Cl. H04W 52/36

(52) U.S. Cl. CPC H04W 52/367; H04W 52/365

(57) ABSTRACT

Embodiments of the present disclosure relate to methods, devices, apparatuses, and computer readable medium of power management in dual-connectivity. The method comprises: in accordance with a determination that a condition for triggering a PHR is met, generating, at a first device, the PHR comprising first PH information for at least one activated first serving cell and second information associated with a deactivated state of a second serving cell; and transmitting the PHR to a second device, the at least one first serving cell being provided by the second device, and the second serving cell being provided by a third device other than the second device In this way, the UE reports PHR information for the PSCell, even when it is deactivated. Based on the PHR information, the network can adjust power shared with the SCG in time, and determine whether to activate the SCG from the viewpoint of UL power.

### FIELD

Embodiments of the present disclosure generally relate to the field of telecommunication and in particular, to devices, methods, apparatus and computer readable storage media of power management in dual-connectivity (DC).

### BACKGROUND

In DC, the UE can be served by a master cell group (MCG) and a secondary cell group (SCG). The MCG and SCG may respectively include a primary cell (PCell) and a primary secondary cell (PSCell), as well as one or more possible secondary cell (SCell). Typically, the PSCell is assumed to be always active, when the DC is configured. With the development of communication technology, it has been proposed to allow the PSCell and thus the whole SCG to be deactivated. This is beneficial for saving UE's power and/or allowing a fast SCG activation. Since releasing and adding SCG take time and costs in terms of several procedures and signaling implemented at the UE and the network, the SCG deactivation aims to achieve a better UE performance with manageable cost of UE's power consumption.

UE power information is provided to the active serving cells in a power headroom reporting (PHR) procedure. Typically, the PHR is triggered when a PSCell is added or a SCell with UL transmission is activated. As per agreements in Rel-17, the SCG can also be configured in deactivated state. When the network has determined that SCG is needed to be activated, the PHR can also be triggered by the SCG activation, and this is a reactive PHR. In some cases, a proactive PHR is expected in the network. For example, the network would like to know the PHR information of the PSCell before the SCG activation. Since the conventional PHR procedure cannot provide the proactive PHR, further improvements are need.

### SUMMARY

In general, example embodiments of the present disclosure provide a solution for power management in DC.

In a first aspect, there is provided a first device. The first device comprises: at least one processor; and at least one memory including computer program codes. The at least one memory and the computer program codes are configured to, with the at least one processor, cause the first device to: in accordance with a determination that a condition for triggering a power headroom report, PHR, is met, generate the PHR comprising first power headroom, PH, information for at least one first serving cell and second information associated with a deactivated state of a second serving cell, the at least one first serving cell being in an activated state; and transmit the PHR to a second device, the at least one first serving cell being provided by the second device, and the second serving cell being provided by a third device other than the second device.

In a second aspect, there is provided a second device. The second device comprises: at least one processor; and at least one memory including computer program codes. The at least one memory and the computer program codes are configured to, with the at least one processor, cause the second device to: receive, from a first device, a power headroom report, PHR, comprising first power headroom, PH, information for at least one first serving cell and second information associated with a deactivated state of a second serving cell, the at least one first serving cell being provided by the second device and operating in an activated state, and the second serving cell being provided by a third device other than the second device; and perform, based on the PHR, power management on at least one of the at least one first serving cell and the second serving cell.

In a third aspect, there is provided a method. The method comprises: in accordance with a determination that a condition for triggering a power headroom report, PHR, is met, generating, at a first device, the PHR comprising first power headroom, PH, information for at least one first serving cell and second information associated with a deactivated state of a deactivated second serving cell, the at least one first serving cell being in an activated state; and transmitting the PHR to a second device, the at least one first serving cell being provided by the second device, and the second serving cell being provided by a third device other than the second device.

In a fourth aspect, there is provided a method. The method comprises: receive, at a second device and from a first device, a power headroom report, PHR, comprising first power headroom, PH, information for at least one first serving cell and second information associated with a deactivated state of a second serving cell, the at least one first serving cell being provided by the second device and operating in an activated state, and the second serving cell being provided by a third device other than the second device; and performing, based on the PHR, power management on at least one of the at least one first serving cell and the second serving cell.

In a fifth aspect, there is provided a first apparatus. The first apparatus comprises: means for in accordance with a determination that a condition for triggering a power headroom report, PHR, is met, generating the PHR comprising first power headroom, PH, information for at least one first serving cell and second information associated with a deactivated state of a second serving cell, the at least one first serving cell being in an activated state; and means for transmitting the PHR to a second apparatus, the at least one first serving cell being provided by the second apparatus, and the second serving cell being provided by a third apparatus other than the second apparatus.

In a sixth aspect, there is provided a second apparatus. The second apparatus comprises: means for receiving, from a first apparatus, a power headroom report, PHR, comprising first power headroom, PH, information for at least one activated first serving cell and second information associated with a deactivated state of a second serving cell, the at least one first serving cell being provided by the second device and operating in an activated state, and the second serving cell being provided by a third apparatus other than the second apparatus; and means for performing, based on the PHR, power management on at least one of the at least one first serving cell and the second serving cell.

In a seventh aspect, there is provided a non-transitory computer readable medium. The non-transitory computer readable medium comprises program instructions for causing an apparatus to perform the method according to the third aspect.

In an eighth aspect, there is provided a non-transitory computer readable medium. The non-transitory computer readable medium comprises program instructions for causing an apparatus to perform the method according to the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 illustrates a schematic diagram illustrating an example multiple entry PHR MAC CE according to some example embodiments of the present disclosure;

FIG. 3A illustrates a signaling chart illustrating an example PHR procedure in DC according to some example embodiments of the present disclosure;

FIG. 3B illustrates a signaling chart illustrating an example PHR procedure in DC according to some example embodiments of the present disclosure;

FIG. 3C illustrates a signaling chart illustrating an example PHR procedure in DC according to some example embodiments of the present disclosure;

FIG. 4 illustrates a flowchart of an example method for power measurement reporting implemented at a terminal device according to example embodiments of the present disclosure;

FIG. 5 illustrates a flowchart of an example method for power measurement reporting implemented at a network device according to example embodiments of the present disclosure;

FIG. 6 illustrates a simplified block diagram of an apparatus that is suitable for implementing example embodiments of the present disclosure; and

FIG. 7 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), a further sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

The PHR provides the serving gNB with the following power information:
Type 1 power headroom: the difference between the nominal UE maximum transmit power and the estimated power for UL-SCH transmission per activated Serving Cell;
Type 2 power headroom: the difference between the nominal UE maximum transmit power and the estimated power for UL-SCH and PUCCH transmission on SpCell of the other MAC entity (i.e. E-UTRA MAC entity in EN-DC, NE-DC, and NGEN-DC cases);
Type 3 power headroom: the difference between the nominal UE maximum transmit power and the estimated power for SRS transmission per activated Serving Cell;
MPE P-MPR: the power backoff to meet the MPE FR2 requirements for a Serving Cell operating on FR2.

In other words, the traditional PHR procedure only applies to active serving cells. When the SCG is deactivated, the UE would not transmit data or control transmission in UL, which means no UE power information (e.g., the Power Headroom Report) will be obtained at MCG or SCG or the deactivated SCG.

As mentioned above, it has been specified that the PHR can be triggered in the following cases:
addition of the PSCell, which may be configured by the network; the PSCell is assumed to be always activated at addition, since the network needs to know the available UL power budget, and
activation of the SCell with configured uplink (UL), since the network needs to know the UL power budget for the SCell; note that this is not the case where the SCell with UL is added or configured.

Since the SCG can also be configured in deactivated state, the network may expect a reactive PHR provided in response to the SCG activation, but also a proactive PHR provided before the SCG activation. For example, the network may intend to activate the SCG from UL power viewpoint, especially when the UL transmission is important (e.g., the first device 110 is at cell egde), or when the SCG is to be used for offloading purposes and wideband transmission with high MCS is intended.

However, according to the conventional PHR procedure, the PHR only provides information on MPE or P_{cMax} associated with the activated serving cell. Thus, the network can only first activate the SCG and then to obtain the information on MPE or P_{cMax} associated with the SCG. From system design point of view, this is an inefficient way since it wastes both system resources and UE energy consumption.

Moreover, since SCG may be operating under FR2, where MPE (i.e., UL maximum power reduction) could be utilized, the network may also expect to know MPE or P_{cMax} values associated with the deactivated SCG.

In order to solve the above and other potential problems, embodiments of the present disclosure provide an improved reporting mechanism for PHR. According to the reporting mechanism, in addition to power information about the activated serving cell, the PHR would also provide power information about PSCell that has been deactivated. The reporting of the PHR can be triggered by SCG deactivation, MPE detection on deactivated SCG and so on. In this way, the UE is capable of using the existing fields in the PHR so that when SCG is deactivated, UE can still send “full” PHR information for the deactivated PSCell.

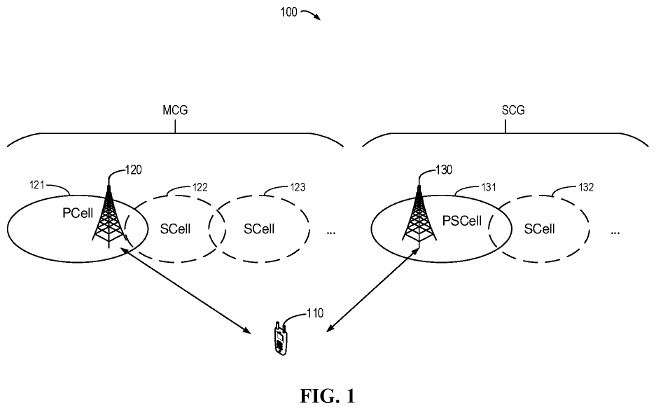

FIG. 1 illustrates an example network environment 100 in which embodiments of the present disclosure can be implemented. In the network environment 100, a first device 110 is configured with CA and in dual-connectivity with a second device 120 and a third device 130. The first device 110 may be implemented as a terminal device (which may be also referred to as the terminal device 110 or UE 110 hereinafter). The second device 120 and the third device 130 may be network devices (which may be referred to as gNBs 120 and 130, or network devices 120 and 130), such as, base stations for providing radio coverage to the first device 110.

As shown in FIG. 1, the second device 120 provides and manages the MCG including a PCell 121. The PCell 121 may operate on a primary frequency, in which the first device 110 either performs the initial connection establishment procedure or initiates the connection re-establishment procedure. The PCell 121 is assumed to be always activated.

The third device 130 provides and manages the SCG including a PScell 131. For dual connectivity operation, the first device 110 may perform random access to the PScell 131 when performing the Reconfiguration with Sync procedure. The PScell 131 may be deactivated for the purpose of power saving, detection of MPE event, and so on.

For each of the MCG and SCG, there may be one or more SCell, for example, SCells 122, 123 and 132 configured for providing additional radio resources to the first device 110. However, SCell is not essential for DC operations, and in some cases, there may be no SCell included in the MCG and SCG. It should be noted that the numbers of SCells included in the MCG and SCG are given in illustrative purpose. Depending on network deployment, resource configuration, actual demand, etc., there may be more or less SCells in each of MCG and SCG.

The first device 110 may communicate with the second device 120 and/or the third device 130 on uplink (UL) or downlink (DL). In particular, the direction from the first device 110 to the second device 120 and/or the third device 130 refers to UL, and the direction from the second device 120 and/or the third device 130 to the first device 110 refers to DL.

During operating, the first device 110 may monitor the radio frequency (RF) exposure level on both the activated serving cells and the deactivated serving cells, and see if it is in compliance with the MPE level, which may be related to proximity. If the MPE event is detected, the first device 110 may apply power backoff to avoid harm to the human body. For example, if the MPE event is detected on the deactivated SCG, the first device 110 may avoid transmit with full transmit power on the SCG once the SCG is activated.

The first device 110 may generate the PHR to provide power information to the MCG, i.e., the second device 120. Once a condition for triggering the PHR is met, the first device 110 may provide the PHR to the second device 120. According to the example embodiments, in addition to the MCG, i.e., the second device 120, the PHR may also include power information for the deactivated serving cell, e.g., the PSCell 131.

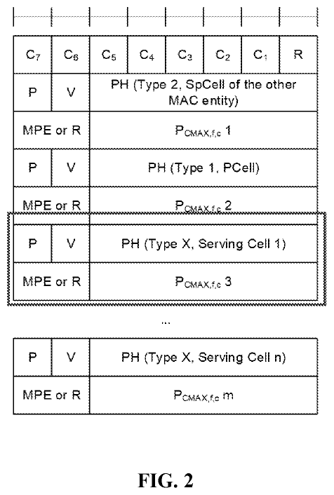

FIG. 2 illustrates a schematic diagram illustrating an example multiple entry PHR MAC CE according to some example embodiments of the present disclosure. As shown in FIG. 2, the PHY may include, e.g., a P-bit field, a MPE field, a field of P_{cMax,c} and possibly the PH field. The PHR MAC CE has a variable size, and may include a bitmap indicating the serving cells, a R bit, a Type 2 PH field and an octet containing the associated P_{CMAX,f,c} field (if reported) for SpCell of the other MAC entity, a Type 1 PH field and an octet containing the associated P_{CMAX,f,c} field (if reported) for the PCell. It may further include, in ascending order based on the ServCellIndex, one or multiple of Type X PH fields and octets containing the associated P_{CMAX,f,c} fields (if reported) for serving cells other than the PCell indicated in the bitmap, where X is either 1 or 3.

The Cᵢ field in the bitmap indicates the presence of a PH field for a serving cell with ServCellIndex i. The Ci field set to 1 indicates that a PH field for the serving cell with ServCellIndex i is reported. The Cᵢ field set to 0 indicates that a PH field for the serving cell with ServCellIndex i is not reported. According to the example embodiments of the present application, the Cᵢ field could be used to indicate the activation status of the PSCell instead of whether the PSCell is reported or not, as the network is capable of deducing from the PHR length if the PSCell is reported, e.g., upon configuration of SCG.

The presence of the field of P-bit indicates that the MAC entity applies power backoff.

The field of V-bit indicates if the PH value is based on a real transmission or a virtual transmission, i.e., a reference format. For Type 1 PH, the V-bit set to 0 indicates a real transmission on PUSCH, and the V-bit set to 1 indicates that a PUSCH reference format is used. For Type 2 PH, the V-bit set to 0 indicates a real transmission on PUCCH, and the V-bit set to 1 indicates that a PUCCH reference format is used. For Type 3 PH, the V-bit set to 0 indicates real transmission on SRS, and the V-bit set to 1 indicates that an SRS reference format is used.

According to the example embodiments, for Type 1, Type 2, and Type 3 PH, the octet containing associated P_{CMAX,f,c} field and the MPE field always follow the octet containing the V-bit, even for the case where the V-bit for the PSCell 131 is set to 1. In other words, the first device 110 is able to report power information for both the activated serving cells and the deactivated serving cells. From the perspective of the network, upon receipt of the PHR, the second device 120 may ignore the V-bit set to 1, and read the following octet. As such, the first device 110 is able to provide full power information about its serving cells.

In some example embodiments, the present of the P-bit may indicate that the MPE even is detected on a corresponding serving cell, which may be either an activated cell or a deactivated cell. Thus, the presence of V-bit or P-bit in the PSCell entry in the MCG PHR may indicate that the MPE and PcMax,C fields for the SCG/PSCell is reported. This allows the PHR reporting information to be fully utilized for the decision on SCG activation.

It is also to be understood that the number of the devices as shown in FIG. 1 are only for the purpose of illustration without suggesting any limitations. For example, the network 100 may include any suitable number of terminal devices and network devices adapted for implementing embodiments of the present disclosure.

Only for ease of discussion, the first device 110 is illustrated as a UE, and the second device 120 and the third device 130 are illustrated as base stations. However, the UE and base station are only given as example implementations of the first device 110, the second device 120 and the third device 130, respectively, without suggesting any limitation as to the scope of the present application. Any other suitable implementations are possible as well.

The communications in the network environment 100 may conform to any suitable standards including, but not limited to, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), and/or any further communication protocols.

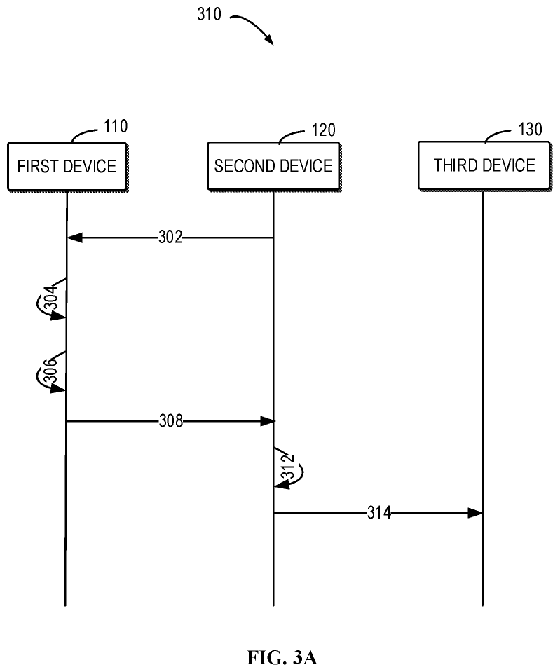

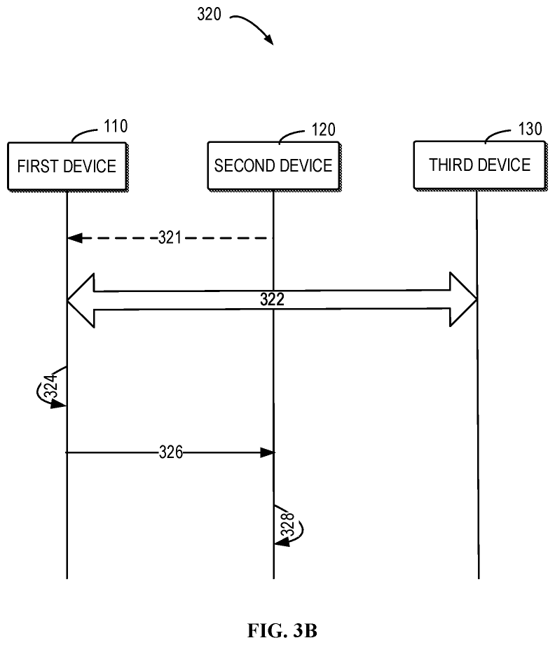

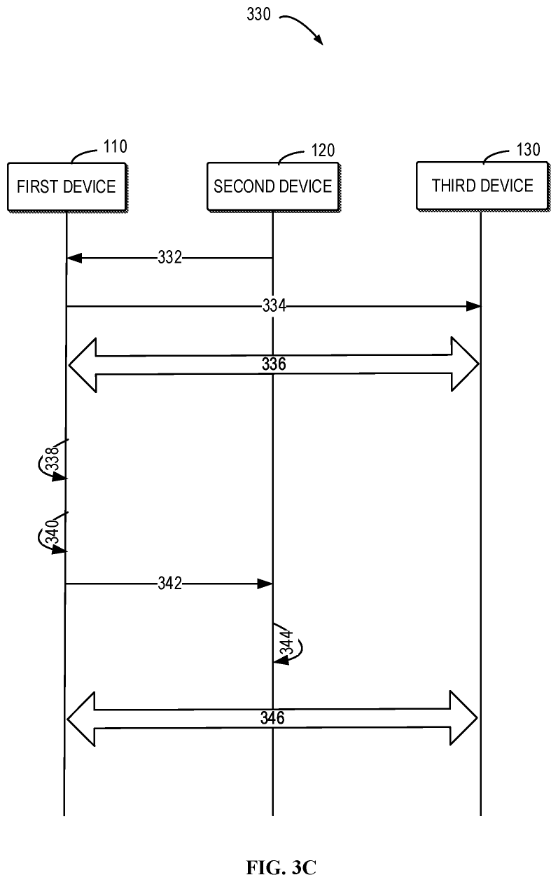

Principle and implementations of the present disclosure will be described in detail below with reference to FIGS. 3A to 3C. FIGS. 3A to 3C respectively illustrate signaling charts illustrating example PHR procedures 310 to 330 in DC according to some example embodiments of the present disclosure. For the purpose of discussion, the processes 310 to 330 will be described with reference to FIGS. 1 and 2. The process 310 may involve the first device 110, the second device 120, and the third device 130.

Now reference is made to FIG. 3A. In the process 310, the condition for triggering the PHR is associated with the detection of MPE event, and the first device 110 operates in dual-connectivity with the SCG being deactivated.

As shown in FIG. 3A, the second device 120 transmits 302 a message for configuring the first device 110 to report MPE event. The first device 110 may then be required to perform needed actions to enable detection of possible need for power backoff.

Upon receipt of the message from the second device 120, the first device 110 detects 304 if the MPE event occurs on the MCG and the deactivated SCG. In the example embodiments, the first device 110 detects at least the MPE event on SCG at 304.

According to the configuration, the first device 110 is required to report the PHR if the MPE event is detected on at least one of the MCG and the SCG. The first device 110 then determines PHR information including, for example, but not limited to, PH values, MPE, P_{cMax} and so on, and generates 306 the PHR.

According to the example embodiments of the present application, the Cᵢ field in the bitmap of the PHR is set to indicate a corresponding activation/deactivation status of the PSCell 131, instead of whether the PSCell 131 is reported, as the network is capable of deducing from the PHR length if the PSCell is reported. Alternatively, it may be predefined that PH information and/or MPE/P_{cMax,c} for PSCell is always reported regardless of its activation/deactivation state, or it may be configured whether to report PH information for deactivated PSCell upon configuration of SCG. In addition, since the PSCell 131 as well as the whole SCG are deactivated, the V-bit in the entry for the PSCell 131 is set to 1. In some example embodiments, the MPE and PcMax,c information of the PSCell 131 are included in the byte following the byte for V-bit.

The first device 110 transmits 308 the PHR to the second device 120. In this case, the second device 120 is aware that whenever PHR is triggered or reported to the MCG, the entry for PSCell 131 will include the MPE and/or P_{cMax,c}, regardless of the PSCell 131 being deactivated or activated. In other words, the full fields in the PSCell 131 entry are always filled. As such, the PHR via MCG can be used to inform the network about SCG PH even when the PSCell 131 is deactivated.

The second device 120 determines 312 whether to activate the SCG based on the PHR. For example, from the MPE information, the second device 120 may determine to activate the SCG, and the second device 120 may then transmit 314 a message for SCG activation to the third device 130. The SCG activation may be implemented based on any currently existing or future developed procedures, and the present disclosure is not limited to this regard.

Now reference is made to FIG. 3B. In the process 320 shown in FIG. 3B, the condition for triggering the PHR is associated with the SCG deactivation. That is, in addition to the PSCell activation, the PSCell deactivation would also trigger reporting of PHR to the MCG.

As shown in FIG. 3B, the second device 120 may transmit 321 a message for configuring the first device 110 to report PHR upon SCG deactivation. However, this is a optional step for the process 320. In some example embodiments, the condition for triggering the PHR upon SCG deactivation may be preconfigured at the first device 110 or standardized in specifications, and thus no signaling from the second device 120 is needed.

The PSCell 131 and thus the SCG are deactivated 322. According to the configuration, the first device 110 is required to report the PHR if the SCG is deactivated.

Thus, upon learning that the SCG is deactivated, the first device 110 may determine the reporting of PHR being triggered, and determines PHR information including, for example, but not limited to, PH values, MPE, P_{cMax} and so on. The first device 110 then generates 324 the PHR including the determined power information.

Similar to process 310, the Cᵢ field in the bitmap of the PHR is set to indicate a corresponding activation/deactivation status of the PSCell 131, instead of whether the PSCell 131 is reported, as the network is capable of deducing from the PHR length if the PSCell is reported, e.g., upon configuration of SCG. In addition, the V-bit in the entry for the PSCell 131 is set to 1, since the PSCell 131 as well as the whole SCG are deactivated. In some example embodiments, the MPE and PcMax,c information of the PSCell 131 are included in the byte following the byte for V-bit. According to the example embodiments of the present application,

The first device 110 transmits 326 the PHR to the second device 120. The second device 120 is aware that the PHR will be triggered upon SCG activation and deactivation. The second device 120 may determine 328 that power sharing with the SCG is no longer needed, and thus the second device 120 may adjust 328 the PH available for the MCG accordingly.

Now reference is made to FIG. 3C. At the beginning of the process 330, both of the MCG and the SCG are activated, and the condition for triggering the PHR comprises a change of normal PSCell PHR triggering conditions, for example, in terms of pathloss change, MPE event, periodic PHR triggering, etc.

As shown in FIG. 3C, the second device 120 may transmit 321 a message for configuring the first device 110 to report the MPE event. The first device 110 then monitor and detect 334 a MPE event occurs on the SCG, for example due to close proximity to a body part. In this case, the first device 110 may need to reduce the transmit power to comply regulatory rules. The PSCell 131 and thus the SCG are deactivated 336.

According to the configuration, the first device 110 continue to monitor 338 the MPE event on both the MCG and SCG, even if the PSCell 131 has been deactivated. During monitoring, the first device 110 detects 340 that the MPE event for FR2 is stopped, that is, the PSCell PHR triggering condition has been changed. In this case, the first device 110 determines that the reporting of PHR is triggered.

In some example embodiments, the Cᵢ field in the bitmap of the PHR is set to indicate a corresponding activation/deactivation status of the PSCell 131, instead of whether the PSCell 131 is reported. Similar to step 324 in process 320, the first device 110 may determine PHR information including, for example, but not limited to, PH values, MPE, P_{cMax} and so on, and generate the PHR. since the PSCell 131 as well as the whole SCG has been deactivated, the V-bit in the entry for the PSCell 131 is set to 1. In some example embodiments, the MPE and PcMax,c information of the PSCell 131 are included in the byte following the byte for V-bit.

The first device 110 transmits 342 the PHR to the second device 120. The second device 120 determines 344 whether to activate the SCG based on the MPE information in the PHR. As from the PHR, the second device 120 is aware that the MPE event has been stopped, thus it is possible to activate the SCG again.

If the second device 120 determines that the SCG can be activated again in 344, the SCG activation may then be implemented between the first device 110 and the third device 130. The SCG activation may be implemented based on any currently existing or future developed procedures, and the present disclosure is not limited to this regard.

In some example embodiments, the PHR may be transmitted by the first device 110 in a more dynamic and flexible manner, for example, in response to a request for PSCell information from the second device 120. The request may be transmitted via downlink control information (DCI), Packet Data Convergence Protocol (PDCP), Radio Link Control (RLC), MAC or RRC signaling.

According to the example embodiments, there is provided an improved mechanism for reporting the PHR. Based on the reporting mechanism, in addition to power information about the activated serving cell, the PHR also includes power information about PSCell that has been deactivated. The reporting of the PHR can be triggered by SCG deactivation, MPE detection on deactivated SCG, a change of PSCell PHR triggering condition, e.g., stop of MPE event, a change of pathloss and so on. As such, the network can be aware of SCG PH via the MCG PHR, regardless of s of PSCell being deactivated or activated. In this way, the network can timely adjust the power sharing with the SCG, and/or determine whether to activate the SCG.

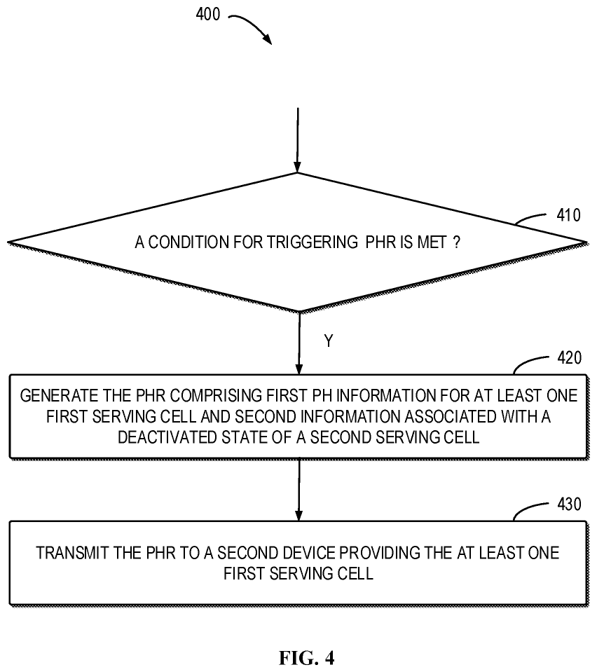

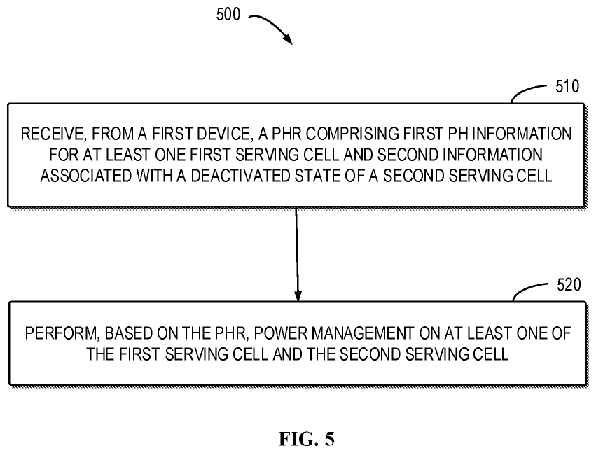

Corresponding to the processes 310 to 330 described in connection with FIGS. 3A to 3C, embodiments of the present disclosure provide a solution for reporting of PHR involving the terminal device, the main node managed the MCG and the secondary node managed the SCG. These methods will be described below with reference to FIGS. 4 and 5.

FIG. 4 illustrates a flowchart of an example method 400 for power measurement reporting implemented at a terminal device according to example embodiments of the present disclosure. The method 400 can be implemented at the first device 110 shown in FIG. 1. For the purpose of discussion, the method 400 will be described with reference to FIG. 1. It is to be understood that method 400 may further include additional blocks not shown and/or omit some shown blocks, and the scope of the present disclosure is not limited in this regard.

The first device 110 is configured to operate in DC with the second device 120 and the third device 130, with the SCG being deactivated. The second device 120 may provide at least one activated first serving cell, for example, the MCG, and the third device 130 may provide a second serving cell, for example, the PSCell 131.

As shown in FIG. 4, at 410, the first device 110 determines whether a condition for triggering the PHR is met. In some example embodiments, the condition for triggering the PHR may include one or more of the following:
the SCG deactivation,
detection of a MPE event on the SCG,
second information for the second serving cell being requested by the network, and
a change of PHR triggering condition associated with at least one of the first serving cell and the second serving cell.

The condition for triggering the PHR may be configured by the network. In some example embodiments, the first device 110 may receive, from the second device 120, a configuration message indicating the condition for triggering the PHR.

In some example embodiments, the first device 110 may detect the MPE, event associated with the second serving cell. In this case, the first device 110 may determine that the condition for triggering the PHR is met.

In some example embodiments, the first device 110 may determine that the condition for triggering the PHR is met upon the SCG deactivation.

In some example embodiments, the first device 110 may only indicate the deactivation status without reporting PH and MPE/P_{cMax,c} for PSCell 131 in the PHR report when the PSCell 131 is deactivated.

In some example embodiments, upon receipt of a request for the second information from the second device 120, the first device 110 may determine that the condition for triggering the PHR is met.

In some example embodiments, the first device 110 may detect a change of PHR triggering condition associated with at least one of the first serving cell and the second serving cell. The first device 110 may then determine that the condition for triggering the PHR is met. The change of PHR triggering condition may include, but not limited to, pathloss change, stop of the MPE event, a periodic PHR triggering, etc.

If the condition is met, at 420, the first device 110 generates the PHR comprising first power headroom, PH, information for at least one first serving cell and second information associated with a deactivated state of a second serving cell. The at least one first serving cell is in an activated state.

In some example embodiments, the at least one first serving cell may include at least one activated SCell in the MCG, and the second serving cell may include a PSCell in the SCG.

In some example embodiments, the second information may comprise an indicator indicative of the deactivated state of the second serving cell. For example, the indicator may be the index Cᵢ corresponding to the PSCell 131 in the bitmap of the PHR.

In some example embodiments, the PHR may further comprise a first indicator set to a first value indicative of the activated state of the at least one first serving cell and a second indicator set to a second value indicative of the deactivated state of the second serving cell. For example, the first value may be 0 and the second value may be 1. The first indicator and the second indicator are contained in a bitmap of the PHR.

In some example embodiments, the second information may be contained in an entry corresponding to the second serving cell in the PHR. The second information may comprise at least one of the following: a field of P-bit, a MPE field, a P_{cMax,c} field, and a PH field.

In some example embodiments, the second information may further comprise a field of V-bit in the entry corresponding to the second serving cell in the PHR, and the V-bit is set to 1 for indicating the deactivated state.

At 430, the first device 110 transmits the PHR to the second device 120.

In some example embodiments, the first device 110 may comprise a terminal device, the second device 120 may comprise a first network device, and the third device 130 may comprise a second network device, and the first device 110 is in dual connectivity with the first network device and the second network device.

According to the example embodiments, there is provided an improved mechanism for reporting of PHR. Based on the improved mechanism, the UE is capable of reporting PH information for the SCG, regardless of whether the PSCell is activated or deactivated. This allows the network to know PHR information of SCG. As such, the network can adjust power shared with the SCG in time, and determine whether to activate the deactivated SCG from the viewpoint of UL power.

FIG. 5 illustrates a flowchart of an example method 500 for power measurement reporting implemented at a network device according to example embodiments of the present disclosure. The method 500 can be implemented at the second device 120 shown in FIG. 1. For the purpose of discussion, the method 500 will be described with reference to FIG. 1. It is to be understood that method 500 may further include additional blocks not shown and/or omit some shown blocks, and the scope of the present disclosure is not limited in this regard.

At 510, the second device 120 receives, from the first device 110, a PHR comprising first PH information for at least one first serving cell and second information associated with a deactivated state of a second serving cell. The at least one first serving cell may be provided by the second device 120, and operate in an activated state. The second serving cell may be provided by the third device 130 other than the second device 120.

In some example embodiments, the second device 120 may transmit, to the first device 110, a configuration message indicating a condition for triggering the PHR. The condition for triggering the PHR may include one or more of the following:
the SCG deactivation,
detection of a MPE event on the SCG,
second information associated with the deactivated state of the second serving cell being requested by the network, and
a change of PHR triggering condition associated with at least one of the first serving cell and the second serving cell.

The transmission of PHR may be in response to a request from the network. In some example embodiments, the second device 120 may transmit, to the first device 110, a request for the second information for the second serving cell.

In some example embodiments, the second information may comprise an indicator indicative of the deactivated state of the second serving cell. For example, the indicator may be the index Ci corresponding to the PSCell 131 in the bitmap of the PHR.

In some example embodiments, the PHR may further comprise a first indicator set to a first value indicative of the activated state of the at least one first serving cell and a second indicator set to a second value indicative of the deactivated state of the second serving cell. For example, the first value may be 0 and the second value may be 1. The first indicator and the second indicator are contained in a bitmap of the PHR.

In some example embodiments, the second information may be contained in an entry corresponding to the second serving cell in the PHR. The second information may comprise at least one of the following: a field of P-bit, a MPE field, a_{PcMax,c} field, and a PH field.

In some example embodiments, the second information may further comprise a field of V-bit in the entry corresponding to the second serving cell in the PHR, and the V-bit is set to 1 for indicating the deactivated state.

At 520, the second device 120 performs, based on the PHR, power management on at least one of the at least one first serving cell and the second serving cell.

In some example embodiments, the second device 120 may determine whether to activate the second serving cell based on a MPE indicated in the second information. If so, the second device 120 may transmit a request for activating the second serving cell to the third device 130.

In some example embodiments, the second device 120 may determine that power sharing with the second serving cell is not needed based on the second information. Based on the determination result, the second device 120 may determine the PH available for the at least one first serving cell. The second device 120 may communicate with the first device 110 based on the PH.

In some example embodiments, the first device 110 may comprise a terminal device, the second device 120 may comprise a first network device, and the third device 130 may comprise a second network device, and the first device 110 is in dual connectivity with the first network device and the second network device.

According to the example embodiments, there is provided an improved mechanism for reporting of PHR. Based on the improved mechanism, the UE will always report full PH information for both the MCG and the SCG, regardless of whether PSCell is activated or deactivated. This allows the network to know PHR information of SCG. As such, the network can adjust power shared with the SCG in time, and determine whether to activate the deactivated SCG.

In some example embodiments, a first apparatus capable of performing any of the method 400 (for example, the first device 110) may comprise means for performing the respective steps of the method 400. The means may be implemented in any suitable form. For example, the means may be implemented in a circuitry or software module.

In some example embodiments, the first apparatus comprises: means for in accordance with a determination that a condition for triggering a power headroom report, PHR, is met, generating the PHR comprising first power headroom, PH, information for at least one first serving cell and second information associated with a deactivated state of a second serving cell, the at least one first serving cell being in an activated state; and means for transmitting the PHR to a second apparatus, the at least one first serving cell being provided by the second apparatus, and the second serving cell being provided by a third apparatus other than the second apparatus.

In some example embodiments, the second information comprises an indicator indicative of the deactivated state of the second serving cell.

In some example embodiments, the first apparatus further comprises: means for detecting a Maximum Permissible Exposure, MPE, event associated with the second serving cell; and means for determine that the condition for triggering the PHR is met.

In some example embodiments, the first apparatus further comprises: means for in accordance with a determination that the second serving cell is deactivated, determining that the condition for triggering the PHR is met.

In some example embodiments, the first apparatus further comprises: means for upon receiving, from the second apparatus, a request for the second information, determining that the condition for triggering the PHR is met.

In some example embodiments, the first apparatus further comprises: means for detecting a change of PHR triggering condition associated with at least one of the first serving cell and the second serving cell; and means for determining that the condition for triggering the PHR is met.

In some example embodiments, the change of PHR triggering condition comprises stop of a Maximum Permissible Exposure, MPE, event associated with the second serving cell.

In some example embodiments, the first apparatus further comprises: means for receiving, from the second apparatus, a configuration message indicating the condition for triggering the PHR.

In some example embodiments, the at least one first serving cell comprises at least one activated secondary cell in a master cell group, and the second serving cell comprises a primary secondary cell in a secondary cell group, the PHR further comprises an first indicator set to a first value indicative of the activated state of the at least one first serving cell, and a second indicator set to a second value indicative of the deactivated state of the second serving cell, and the first indicator and the second indicator are contained in a bitmap of the PHR.

In some example embodiments, the second information is contained in an entry corresponding to the second serving cell in the PHR, and the second information comprises at least one of the following: a field of P-bit, a Maximum Permissible Exposure, MPE, field, a PcMax,c field, and a PH field.

In some example embodiments, the second information comprises a field of V-bit in the entry, and the V-bit is set to 1 for indicating the deactivated state.

In some example embodiments, the first apparatus comprises a terminal device, a second apparatus comprises a first network device, and a third apparatus comprises a second network device, the terminal device is in dual connectivity with the first network device and the second network device.

In some example embodiments, a second apparatus capable of performing any of the method 500 (for example, the second device 120) may comprise means for performing the respective steps of the method 500. The means may be implemented in any suitable form. For example, the means may be implemented in a circuitry or software module.

In some example embodiments, the second apparatus comprises: means for receiving, from a first apparatus, a power headroom report, PHR, comprising first power headroom, PH, information for at least one activated first serving cell and second information associated with a deactivated state of a second serving cell, the at least one first serving cell being provided by the second device and operating in an activated state, and the second serving cell being provided by a third apparatus other than the second apparatus; and means for performing, based on the PHR, power management on at least one of the at least one first serving cell and the second serving cell.

In some example embodiments, the second information comprises an indicator indicative of the deactivated state of the second serving cell.

In some example embodiments, the second apparatus further comprises: means for transmitting, to the first apparatus, a configuration message indicating a condition for triggering the PHR.

In some example embodiments, the condition for triggering the PHR comprises at least one of the following: a Maximum Permissible Exposure, MPE, event associated with the second serving cell being detected, a deactivation of the second serving cell, and a change of PHR triggering condition associated with the second serving cell.

In some example embodiments, the second information is contained in an entry corresponding to the second serving cell in the PHR, and the second information comprises at least one of the following: a field of P-bit, a Maximum Permissible Exposure, MPE, field, a PcMax,c field, and a PH field.

In some example embodiments, the second information comprises a field of V-bit in the entry, and the V-bit is set to 1 for indicating the deactivated state.

In some example embodiments, the at least one first serving cell comprises at least one activated secondary cell in a master cell group, and the second serving cell comprises a primary secondary cell in a secondary cell group, the PHR further comprises a first indicator set to a first value indicative of the activated state of the at least one first serving cell, and a second indicator set to a second value indicative of the deactivated state of the second serving cell, and the first indicator and the second indicator are contained in a bitmap of the PHR.

In some example embodiments, the means for performing the power management comprises: means for determining whether to activate the second serving cell based on a Maximum Permissible Exposure, MPE indicated in the second information; and means for in accordance with a determination of the second serving cell to be activated, transmitting a request for activating the second serving cell to the third apparatus.

In some example embodiments, the means for performing the power management comprises: means for determining that power sharing with the second serving cell is not needed based on the second information; means for determining a PH available for the at least one first serving cell; and means for communicate with the first apparatus based on the PH.

In some example embodiments, the second apparatus further comprises: means for transmitting, to the first apparatus, a request for the second information for the second serving cell.

In some example embodiments, the first apparatus comprises a terminal device, a second apparatus comprises a first network device, and a third apparatus comprises a second network device, the terminal device is in dual connectivity with the first network device and the second network device.

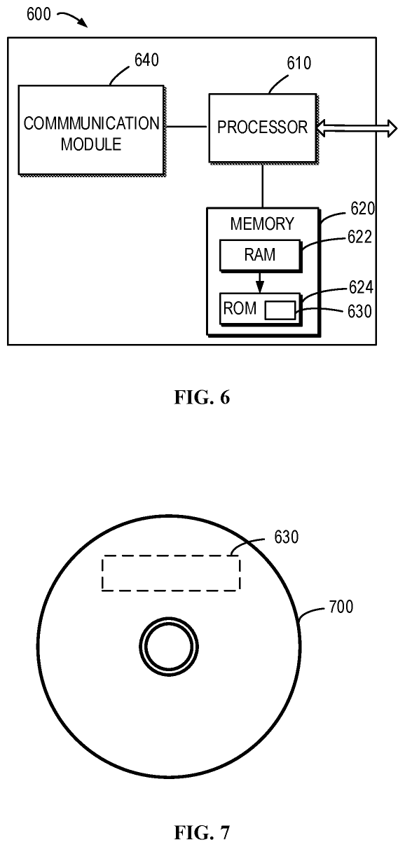

FIG. 6 is a simplified block diagram of a device 600 that is suitable for implementing embodiments of the present disclosure. The device 600 may be provided to implement the communication device, for example the first device 110 and the second device 120 as shown in FIG. 1. As shown, the device 600 includes one or more processors 610, one or more memories 620 coupled to the processor 610, and one or more transmitters and/or receivers (TX/RX) 640 coupled to the processor 610.

The TX/RX 640 may be configured for bidirectional communications. The TX/RX 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage media. Examples of the volatile memories include, but are not limited to, a random access memory (RAM) 622 and other volatile memories that will not last in the power-down duration.

A computer program 630 includes computer executable instructions that may be executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIG. 2. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7. shows an example of the computer readable medium 700 in form of CD or DVD. The computer readable medium has the program 630 stored thereon.

Various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations. It is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 or 500 as described above with reference to FIGS. 4-5. Generally, program modules may include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory including computer program codes;
the at least one memory and the computer program codes are configured to, with the at least one processor, cause the first device at least to:
in accordance with a determination that a condition for triggering a power headroom report, PHR, is met, generate the PHR comprising first power headroom, PH, information for at least one first serving cell and second information associated with a deactivated state of a second serving cell, the at least one first serving cell being in an activated state; and
transmit the PHR to a second device, the at least one first serving cell being provided by the second device, and the second serving cell being provided by a third device other than the second device.

2. The first device of claim 1, wherein the second information comprises an indicator indicative of the deactivated state of the second serving cell.

3. The first device of claim 1, wherein the at least one memory and the computer program codes are configured to, with the at least one processor, further cause the first device to:
detect a Maximum Permissible Exposure, MPE, event associated with the second serving cell; and
determine that the condition for triggering the PHR is met.

4. The first device of claim 1, wherein the at least one memory and the computer program codes are configured to, with the at least one processor, further cause the first device to:
in accordance with a determination that the second serving cell is in the deactivated state, determine that the condition for triggering the PHR is met.

5. The first device of claim 1, wherein the at least one memory and the computer program codes are configured to, with the at least one processor, further cause the first device to:
upon receiving, from the second device, a request for the second information for the second serving cell, determine that the condition for triggering the PHR is met.

6. The first device of claim 1, wherein the at least one memory and the computer program codes are configured to, with the at least one processor, further cause the first device to:
detect a change of PHR triggering condition associated with at least one of the first serving cell and the second serving cell; and
determine that the condition for triggering the PHR is met.

7. The first device of claim 6, wherein the change of PHR triggering condition comprises stop of a Maximum Permissible Exposure, MPE, event associated with the second serving cell.

8. The first device of claim 1, wherein the at least one memory and the computer program codes are configured to, with the at least one processor, further cause the first device to:
receive, from the second device, a configuration message indicating the condition for triggering the PHR.

9. The first device of claim 1, wherein the at least one first serving cell comprises at least one activated secondary cell in a master cell group, and the second serving cell comprises a primary secondary cell in a secondary cell group, the PHR further comprises an first indicator set to a first value indicative of the activated state of the at least one first serving cell, and a second indicator set to a second value indicative of the deactivated state of the second serving cell, and the first indicator and the second indicator are contained in a bitmap of the PHR.

10. The first device of claim 1, wherein the second information is contained in an entry corresponding to the second serving cell in the PHR, and the second information comprises at least one of the following:
a field of P-bit,
a Maximum Permissible Exposure, MPE, field,
a PcMax,c field, and
a PH field.

11. The first device of claim 10, wherein the second information comprises a field of V-bit in the entry, and the V-bit is set to 1 for indicating the deactivated state.

12. The first device of claim 1, wherein the first device comprises a terminal device, a second device comprises a first network device, and a third device comprises a second network device, the terminal device is in dual connectivity with the first network device and the second network device.

13. A second device, comprising:
at least one processor; and
at least one memory including computer program codes;
the at least one memory and the computer program codes are configured to, with the at least one processor, cause the second device at least to:
receive, from a first device, a power headroom report, PHR, comprising first power headroom, PH, information for at least one first serving cell and second information associated with a deactivated state of a second serving cell, the at least one first serving cell being provided by the second device and operating in an activated state, and the second serving cell being provided by a third device other than the second device; and
perform, based on the PHR, power management on at least one of the at least one first serving cell and the second serving cell.

14. (canceled)

15. The second device of claim 13, wherein the at least one memory and the computer program codes are configured to, with the at least one processor, further cause the second device to:
transmit, to the first device, a configuration message indicating a condition for triggering the PHR.

16. The second device of claim 15, wherein the condition for triggering the PHR comprises at least one of the following:
a Maximum Permissible Exposure, MPE, event associated with the second serving cell being detected,
a deactivation of the second serving cell, and
a change of PHR triggering condition associated with the second serving cell.

17-18. (canceled)

19. The second device of claim 13, wherein the at least one first serving cell comprises at least one activated secondary cell in a master cell group, and the second serving cell comprises a primary secondary cell in a secondary cell group, the PHR further comprises a first indicator set to a first value indicative of the activated state of the at least one first serving cell, and a second indicator set to a second value indicative of the deactivated state of the second serving cell, and the first indicator and the second indicator are contained in a bitmap of the PHR.

20. The second device of claim 13, wherein the at least one memory and the computer program codes are configured to, with the at least one processor, cause the second device to perform the power management by:
determining whether to activate the second serving cell based on a Maximum Permissible Exposure, MPE indicated in the second information; and
in accordance with a determination of the second serving cell to be activated, transmitting a request for activating the second serving cell to the third device.

21. The second device of claim 13, wherein the at least one memory and the computer program codes are configured to, with the at least one processor, cause the second device to perform the power management by:
determining that power sharing with the second serving cell is not needed based on the second information;
determining a PH available for the at least one first serving cell; and
communicating with the first device based on the PH.

22. The second device of claim 13, wherein the at least one memory and the computer program codes are configured to, with the at least one processor, further cause the second device to:
transmit, to the first device, a request for the second information for the second serving cell.

23. (canceled)

24. A method comprising:
in accordance with a determination that a condition for triggering a power headroom report, PHR, is met, generating, at a first device, the PHR comprising first power headroom, PH, information for at least one first serving cell and second information associated with a deactivated state of a deactivated second serving cell, the at least one first serving cell being in an activated state; and
transmitting the PHR to a second device, the at least one first serving cell being provided by the second device, and the second serving cell being provided by a third device other than the second device.

25-28. (canceled)
